(19) United States
(12) Patent Application Publication
(10) Pub. No.: US 2017/0124924 A1
(43) Pub. Date: May 4, 2017

(54) Hollow Body with Attractive Movement Effects

(71) Applicant: Alfred Ewald, Eltville (DE)

(72) Inventor: Alfred Ewald, Eltville (DE)

(21) Appl. No.: 15/296,112

(22) Filed: Oct. 18, 2016

(30) Foreign Application Priority Data
Oct. 30, 2015 (DE) 102015013994.0
Oct. 12, 2016 (DE) 102016119401.8

(51) Int. Cl. G09F 19/02

(52) U.S. Cl. CPC G09F 19/02

(57) ABSTRACT

The invention relates to a hollow body with attractive movement effects. The transparent hollow body is filled with a viscous transparent liquid (F). This body contains two types of small-part bodies used as floating bodies (S) and even smaller-sized bodies as drive bodies (K). The floating bodies (S) have an arbitrary average diameter and the drive elements (K) preferably have a significantly smaller diameter than the floating bodies (S). The density of the material of the floating bodies (S) is always less than that of the material of the drive bodies (K). The hollow body contains two perforated plate plates (3) spaced apart from one another, provided as horizontal intermediate walls, so that the hollow body forms a central sub-chamber as well as an upper and a lower sub-chamber (2) for the plurality of floating and drive bodies (S; K).

### CROSS REFERENCE TO RELATED APPLICATIONS

This application claims the priority of DE 102015013994.0 filed on Oct. 30, 2015 and the priority of DE 102016119401.8 filed on Oct. 12, 2016; all applications are incorporated by reference herein in their entirety.

### BACKGROUND

The invention relates to a hollow body with attractive movement effects, the transparent hollow body is filled with a low to medium viscosity, preferably transparent liquid.

The advertising and gift articles industry has a general need for effective articles, eg for articles with colour and movement effects. An additional effect should also be achieved, such as, for example, an at least roughly reproducible movement time. This is often achieved with the aid of unstained or dyed liquids with a specific effect in transparent bodies made of plastic or glass.

Increased effects with the co-application of liquids are known, for example, from DE 3813748 C2, in which coloured plastic particles usually rise from the bottom to the top. Also known are the commonly known so-called snow balls, in which snow falls are imitated for a few moments by shaking a transparent body, which contains white plastic particles in addition to a clear liquid. Also known according to the hourglass principle are plastic bodies, which contain a viscous liquid, in which beads with metallic effect gently sink downwards.

Also known are hollow bodies of glass unstructured innerly in which, besides a liquid, there are two types of solid bodies differing in their density, which are mixed after shaking the hollow body and then float for some time almost in the liquid and then sluggishly separate from each other and settle. This technique shows little action and does not allow a useful reproducible movement time of the solid particles.

A longer lasting, more lively effect has a high attention and therefore market value for advertising and gift items, because the gift presented with such articles can enjoy a longer lasting moving process without manual intervention. But also a reproducible time has a high value in this industry. As a result of the gravitational effect, the effects, as explained in the prior art, are relatively limited in time and/or bring about relatively little movement and mobility of the particles. Frequently the bodies must be turned over after the movement has ended, in order to initiate the process again.

From U.S. Pat. No. 1,912,602 an opaque hollow body is known in which a liquid and two sets of gemstones of specific density tend to gradually rise by shaking so that one set of shiny parts rises gradually and the other set of shiny parts remains floating or rises only less rapidly.

### SUMMARY

The invention relates to a hollow body with attractive movement effects. The transparent hollow body is filled with a viscous transparent liquid (F). This body contains two types of small-part bodies used as floating bodies (S) and even smaller-sized bodies as drive bodies (K). The floating bodies (S) have an arbitrary average diameter and the drive elements (K) preferably have a significantly smaller diameter than the floating bodies (S). The density of the material of the floating bodies (S) is always less than that of the material of the drive bodies (K). The hollow body contains two perforated plate plates (3) spaced apart from one another, provided as horizontal intermediate walls, so that the hollow body forms a central sub-chamber as well as an upper and a lower sub-chamber (2) for the plurality of floating and drive bodies (S; K).

### DETAILED DESCRIPTION

It is an object of the invention to provide a hollow body which produces a new creative extension by means of a peculiar, particularly long-lasting and vigorous movement sequence, but also largely reproducible timings with respect to the time of movement of the body in the liquid.

The object of the invention is achieved as follows
the hollow body contains two types of preferably small-part bodies as floating bodies and, on the other hand, even relatively small-sized bodies as drive bodies, the density of which is increased significantly compared to its unmodified design by several additives,
in the hollow body, at least one perforated plate, preferably two perforated plate plates spaced apart from one another, are provided as horizontal intermediate walls, and thus the hollow body forms a central sub-chamber as well as an upper and a lower sub-chamber for the plurality of floating and drive bodies, and
the floating bodies have, in principle, any average diameter,
the drive bodies in principle have an arbitrary average diameter but, in typical concrete applications, have a significantly smaller diameter than the floating bodies,
the density of the material of the floating bodies is always less than that of the material of the drive bodies, and
the density of the liquid is slightly above or slightly below the value of the density of the material of the floating bodies, but is preferably slightly less than the value of the density of the floating bodies.

Further features and embodiments of the hollow body according to the invention are given in the subclaims.

The articles constructed according to the invention allow in particular a very observable turbulent movement process, which may last several minutes without requiring manual manipulation.

According to the invention, this is achieved by combining the following features:

1.

The transparent hollow body is filled with a low to medium viscosity, preferably transparent liquid which is preferably not coloured, but can also be dyed.

2.

In the hollow body there are two types of preferably small-part bodies, namely floating bodies, preferably plastic granules or plastic beads, and, furthermore, even smaller-part drive bodies, preferably of glass, metal or plastic, the density of which is increased significantly compared to their unmodified design by additives.

3.

The small-part floating bodies may, in principle, have any average diameter. The term “average diameter” is used here since, in addition to the preferred spherical shape, it is also possible to use granules which have an irregular shape, for example plastic granules, which are intended for plastic injection molding. In preferred applications the average diameter of the floating bodies is in the range 2 to 6 mm. However, only one or only few very large floating bodies can be used. For instance replicas of balls such as soccer balls, tennis balls and the like. The floating bodies in the hollow body can have only one or alternatively different colors next to each other. The floating bodies are generally not concrete figurative figures.

However, it is also possible to use spatial figures as floating bodies. Here, for example, letters, numbers, stars, flower heads, even elongated bodies such as flowers with stem, miniature cigarettes, screws and the like are considered. Floating bodies can also be used as symbols provided with symbols, for example applied by pressure, such as miniature national flags, company logos or the like. Furthermore, white snowflake imitation can also be used as a floating body.

4.

In a particular embodiment, a motion effect is generated by movably mounting floats on a fixed horizontal or vertical axis where they are caused to rotate by the drive bodies. These floating bodies then have, for example, shapes similar to those of wind, water or toothed gears. These are caused to rotate by driving the drive bodies onto surface parts of the wheel-shaped bodies in such a way that a rotational movement is triggered by the gravitational force of the drive bodies.

5.

The drive bodies can in principle have an arbitrary average diameter but, in typical concrete applications, a significantly smaller diameter than the floating bodies. In a preferred application, the drive bodies consist of non-coloured glass, for example glass beads, since their transparency, which is close to the invisibility, triggers astonishment at the movements described below. If, for example, the average diameter of the floating bodies is approximately 4 mm, the average diameter of the drive bodies is selected to be approximately 0.5 mm.

6.

In addition to the diameter and shape of the floating bodies and the drive bodies, the interplay of the density of the materials is of decisive importance. According to the invention, the density of the material of the floating bodies is generally less than the density of the material of the drive bodies. The difference is not limited in size, but is preferably at least double.

7.

The desired, longer-lasting movement process in the hollow body is achieved by providing at least one perforated plate, preferably two spaced-apart perforated plates, in the hollow body as a horizontal intermediate wall. The perforated plate has the important task of allowing the drive bodies to be trickled continuously, uniformly and for a longer time into the interior of the hollow body, in which the desired movement process takes place.

The perforated plate is described in more detail below.

Above the perforated plate there is a very large number of the small-sized drive bodies at the beginning of the movement process. These are prevented by the perforated plate, from trickling down generally unbraked. Because the available bores always allow only a small part of the drive bodies to be quasi-dosed, which is very uniform for the desired effect.

The distribution and size of the holes in the perforated plate now make it possible to modify the movement process in a variety of ways. Many drill holes mean a faster movement; while a few drill holes provide a slower run. A symmetrical arrangement of the bores ensures a uniform trickling of the drive bodies. On the other hand, an asymmetrical arrangement of the bores causes the drive bodies to trickle into preferred sectors of the hollow body in which the floating bodies are located. In the last-mentioned manner, for example, the floating bodies can be transformed into a kind, swarm-shaped, irregular rotation, and in the case of larger, preferably spherical floating bodies, into a continuous rotation.

The shape of the holes in the perforated plate is generally circular. However, it is also possible to choose other contours such as rectangular, oval holes and also long holes. The long holes are, inter alia, intended to prevent air bubbles in the hollow body from being placed in front of the bores from below, which would hinder the passage of drive bodies. Small air bubbles are generally not to be prevented in the hollow body, but on the other hand they can also be desired as air cushions because they counteract an excessive pressure increase which could cause the hollow body to burst open at connecting points. However, a few oval bores or long holes can be dimensioned in such a way that the air bubbles which otherwise obstruct the passage of the drive bodies are directed to the highest points in the hollow body by corresponding handling of the hollow body. The dimensioning of the long holes can be selected in such a way that although the air can pass straight through, there is not an excessive number of drive bodies thereafter.

8.

In addition to the properties profiles of the floating bodies and the drive bodies described, certain properties of the transparent liquid in the hollow body also occur. These are characterized in the following.

The viscosity of the liquid is not limited downwards, but preferably has a value of up to 100 mPas. In the practical realisation of the invention, the following may be selected: the lower the viscosity, the faster the floats move; the higher the viscosity, the slower it moves. In combination with the hole sizes in the perforated plate, one can achieve the desired parameters of the acquirer with respect to the approximate movement time.

The invention includes, as a further important feature, a density of the liquid adjusted to the densities of the floating bodies and the drive bodies. This requires a value similar in size to that of the material of the floating bodies. The density of the liquid is slightly above or slightly below the value of the density of the material of the floating bodies, but is preferably slightly less than the value of the density of the floating bodies. In the rest state, the floating bodies should preferably float on the liquid or be able to rest more or less suspended in the liquid.

### BRIEF DESCRIPTION OF THE DRAWINGS

The idea behind the invention is described more in detail in the following description using an embodiment example illustrated on the drawings. The figures are as follows:

FIG. 1A shows a side view of the hollow body according to the invention,

FIG. 1B shows another side view of the hollow body according to the invention,

FIG. 1C shows a cross-sectional view along the arrows on the hollow body according to the invention,

FIG. 2 shows the hollow body according to FIG. 1A with the necessary content components in the rest position, and

FIG. 3 shows the hollow body some time after the rotation from the rest position.

### DETAILED DESCRIPTION OF THE PREFERRED EMBODIMENTS

Before describing the overall inventive effect according to the above, it is necessary first to describe the structural structure of the hollow body which contains the floating bodies (S), the drive bodies (K) and the liquid (F).

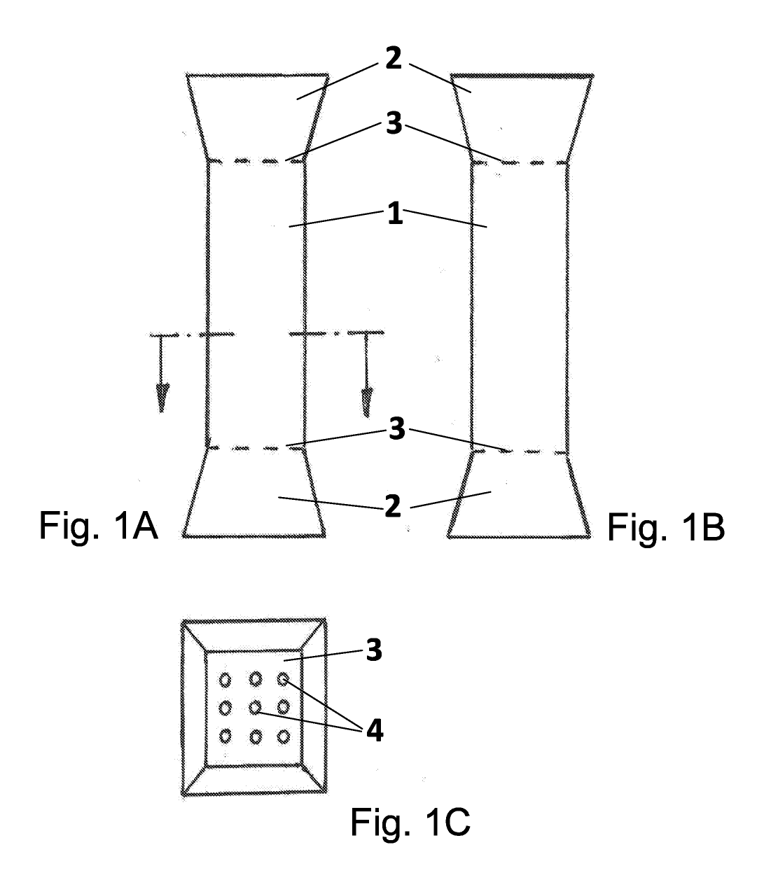

FIG. 1 shows the basic structure of the required hollow body, preferably of plastic, with a square cross-section. However, the cross-section can also be shaped differently, for example rectangular or cylindrical. The hollow body comprises a central chamber (1), which is adjoined by at least one supply chamber (2) for the drive bodies (K). In most applications, it is advantageous if, for the drive bodies (K), a supply chamber (2) is formed above and below the central chamber (1).

The storage chamber (2) is preferably conically expanded in order to provide a great deal of space for the drive bodies (K), which maximizes the effort to achieve a long-lasting inventive effect in the hollow body.

Between the central chamber (1) and the storage chambers (2) there is at least one perforated plate (3). The drive bodies (K) are introduced into the central chamber (1) and in the starting position in one of the two storage chambers (2). The remaining volume of the entire hollow body is filled with liquid (F), which is not shown in detail in the drawings.

The perforated plate (3) has at least one bore (4), but preferably several. The diameters of the holes (4) are matched to the diameters of the floating bodies (S) and the drive bodies (K). The holes (4) are dimensioned in such a way that the floating bodies (S) used cannot pass through them while the drive bodies (K) can pass through the holes (4). Advantageously, a hole diameter is selected for the perforated plates (3), which has at least twice the diameter of the drive bodies (K), so that the drive bodies (K) do not become jammed when they pass through the holes (4).

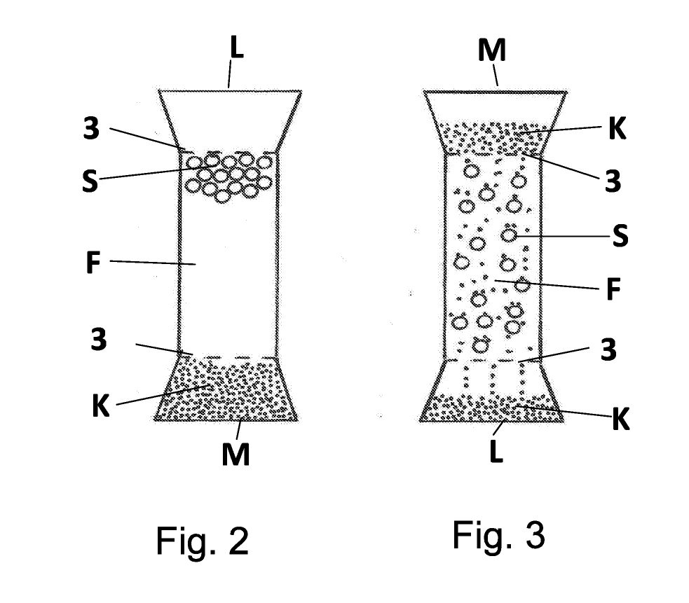

Following these introductory explanations, the effect according to the invention will now be explained with reference to FIGS. 2 and 3.

FIG. 1 shows in a side view the inner structure of a hollow body according to the invention in the unfilled state, namely with the central chamber (1), the supply chambers (2), the perforated plates (3) with the bores (4).

FIG. 2 shows the hollow body according to FIG. 1 with the above-mentioned content components. The hollow body stands on its foot (M).

FIG. 3 shows the aforementioned hollow body some time after it has been turned, while standing on its other foot (L).

Drive bodies (K) trickle down from the supply chambers (2) through the holes (4) of the perforated plate (3) in the liquid (F), for example, water. In doing so, they hit the floating bodies (S). If water is used, these can consist, for example, of ABS (acrylonitrile-butadiene-styrene copolymer) resin with a density of 0.99 g/cm³.

Since the floating bodies (S) have a lower density than the drive bodies (K), the floating bodies (S) receive a movement pulse downwards. Since the drive bodies (K) are constantly trickling downwards in large numbers, all the floating bodies (S) are moving like a swarm. Floating bodies (S) which partially or temporarily receive fewer hits by the drive bodies (K) than others rise again until they experience anew a downward movement pulse from a larger number of drive bodies (K). In this way, nearly all of the floating bodies (S) can be located in an upwardly and downwardly directed movement for a longer time in a swirling process.

If the hollow body is not viewed from the immediate vicinity, that is to say from a distance so that the eye does not recognize the finely divided glass beads, the whole works as an optical perpetual motion mobile. If, however, the movement process is terminated because no drive body (K) is able any longer to trickle through the central chamber (1), the process can be initiated again and again by inverting the hollow body.

It is also possible that with the previously described effect, several partial bodies can be combined side by side, one behind the other or one above the other.

In a further specific embodiment (not shown), the hollow body has three perforated plates (3) one above the other. In this case, two perforated plates (3) are provided for the partial separation of the drive bodies (K), namely a perforated plate (3) in the upper region and in the lower region of the hollow body. A further perforated plate (3) is arranged approximately in the center of the hollow body, which is designed in such a way that it preferably results in a generally slower passage of all drive bodies (K) opposite the two other perforated plates (3). Two further partial chambers are thus formed, which are provided for the floating bodies (S) separated from one another. In each of these last-mentioned two sub-chambers, different floats (S) may be introduced, for example, in quantity, size and colour. With this arrangement, it is possible, in addition to the parameters already described elsewhere, to achieve the approximate movement times which are very in demand in the advertising and gift articles industry.

So a special time target is as follows: After turning the hollow body, a time t₁ is achieved when all the drive bodies (K) leave the uppermost floating body sub-chamber and a time t₂, when they have fully arrived in the lowermost sub-chamber. Three times can thus be achieved: t₁, t₂ and from the sum t₁ plus t₂.

It is also possible to apply the basic principle of the invention not only in handy advertising and gift articles, but also in significantly larger hollow bodies, in order to create artistic objects. In this application, electromotive drives are preferably used for the rotation, or the drive bodies are mechanically transported, for example by a pumping device. For such an embodiment, only one perforated plate (3) is required.

It can be installed in public areas such as streets, squares and parks, but also in interior spaces such as entrance halls, sales rooms, halls, waiting rooms, discotheques. In the case of such significantly larger hollow bodies, compared to advertising and gift articles, the possibility exists of using bodies which are molded as plastic bodies, as floating bodies (S). For the sake of clarity, fruit, blossoms, colourful eggs, technical components, coins, etc. are illustrated as representatives.

It is also possible to combine such larger objects with electrical lighting. Thus the effect can also be applied in the dark. A special variant is the one in which special effects are achieved with black light. In this case, the floating bodies (S) contain luminous components under blacklight influence.

### LIST OF REFERENCE NUMERALS

F Transparent liquid

S Floating bodies

K Drive bodies

M Foot

L Foot

1 Cenral chamber

2 Supply chamber

3 Perforated plate

4 Bore

1. A hollow body with attractive movement effects, wherein the transparent hollow body is filled with a low to medium viscosity, preferably transparent liquid (F), characterised in that
the hollow body contains two types of preferably small-part bodies as floating bodies (S) and, on the other hand, even relatively small-sized bodies as drive bodies (K), the density of which is increased significantly compared to its unmodified design by several additions,
in the hollow body, at least one perforated plate (3), preferably two perforated plate plates (3) spaced apart from one another, are provided as horizontal intermediate walls, and thus the hollow body forms a central sub-chamber as well as an upper and a lower sub-chamber (2) for the plurality of floating and drive bodies (S; K), and that
the floating bodies (S) have, in principle, any average diameter,
the drive bodies (K) can in principle have an arbitrary average diameter but, in typical concrete applications, a significantly smaller diameter than the floating bodies (S).
the density of the material of the floating bodies (S) is always less than that of the material of the drive bodies (K), and
the density of the liquid (F) is slightly above or slightly below the value of the density of the material of the floating bodies, but is preferably slightly less than the value of the density of the floating bodies (S).

2. A hollow body according to claim 1, characterised in that in the perforated plate (3) a plurality of holes (4) of the same and/or different size and distribution are formed symmetrically or asymmetrically.

3. A hollow body according to claim 2, characterised in that the holes (4) are adapted to the diameter of the floating bodies (S) and the drive bodies (K) and dimensioned such that through them the floating bodies do not fit therethrough, while the drive bodies (K) can pass through the bores (4).

4. A hollow body according to claim 2, characterised in that the holes (4) in the perforated plate (3) are circular, rectangular, oval and the like, or are formed as elongated holes.

5. A hollow body according to claim 1, characterised in that the floating bodies (S) preferably have a spherical shape, an irregular shape, or are constructed as spatial figures.

6. A hollow body according to claim 1, characterised in that the floating bodies (S) have only one or adjacent different colours. A hollow body according to claim 1, characterised in that the drive bodies (K) are made preferably of non-coloured glass, for example glass beads, and the floating bodies (S) from plastic granules or plastic beads.
